(19) United States
(12) Patent Application Publication
(10) Pub. No.: US 2024/0338953 A1
(43) Pub. Date: Oct. 10, 2024

(54) DEVICE FOR DETECTING AN OBJECT AND/OR FOR DETERMINING A DISTANCE TO AN OBJECT METHOD THEREFORE

(71) Applicant: Baden-Württemberg Stiftung gGmbH, Stuttgart (DE)

(72) Inventors: Daniel Claus, Illertissen (DE); Igor Alekseenko, Neu-Ulm (DE); Florian Hausladen, Blaustein (DE); Felix Glöckler, Ulm (DE); Giancarlo Pedrini, Stuttgart (DE); Alexander Gröger, Stuttgart (DE)

(21) Appl. No.: 18/626,536

(22) Filed: Apr. 4, 2024

(30) Foreign Application Priority Data
Apr. 5, 2023 (EP) 23166738.7

(51) Int. Cl. G06V 20/58

(52) U.S. Cl. CPC G06V 20/58

(57) ABSTRACT

The invention relates to a measuring device and a method for detecting at least one object and/or for determining an object distance, e.g., for use in road traffic. The measuring device can comprise: a light source for emitting light with a predetermined coherence length; a beam splitter for splitting the emitted light into measuring and reference beams; a transfer unit that converts the reference beam into a plurality of sub-reference beams; an image data acquisition unit for acquiring image data resulting from a superposition of the sub-reference beams with an object beam comprising at least a part of the measuring beam that was scattered and/or reflected by the at least one object; and an evaluation unit for evaluating the image data, wherein the reference beam transfer unit comprises spatially separated optical paths having different optical lengths, along which the sub-reference beams are guided to the image data acquisition unit.

### CROSS REFERENCE TO RELATED APPLICATIONS

The present application claims priority to European Utility Model Application No. 23 166 738.7, filed Apr. 5, 2023, which is incorporated herein by reference.

### DESCRIPTION

The invention relates to a device and a method for detecting at least one object and/or for determining at least one object distance, in particular for use in road traffic. The invention further relates to a vehicle including the device according to the invention.

In road traffic in particular, the automatic detection of obstacles and/or other road users by means of machine image processing is playing an ever-greater role. Reliable sensor systems are essential, in particular for autonomous vehicles, primarily automobiles. However, the accuracy and reliability of such sensor systems depends strongly on environmental influences such as weather conditions. In poor visibility conditions, such as those during rain, snowfall and/or fog, the accuracy and/or reliability of such sensor systems can decrease significantly or, in the worst case, no longer exist at all. But not only the weather-related influence of the environment, but also interference from other road users, in particular by their sensors, which are based e.g. on methods such as TOF (“Time-of-flight”) or Lidar (“Light imaging, detection and ranging”), can have a negative impact on sensor systems. This particularly affects conventional sensor systems that are based on the evaluation of amplitude and/or frequency modulated signals.

It is therefore an object of the present invention to provide a device and a method which improves the detection of at least one object and/or the determination of at least one object distance, in particular in road traffic. A further object of the present invention is to provide a vehicle with increased safety and/or improved comfort.

This object is achieved by the subject matters of the independent claims. Advantageous embodiments are subject of the subclaims.

A first independent aspect for achieving the object relates to a measuring device for detecting at least one object and/or for determining at least one object distance, in particular for use in road traffic, comprising:
a light source for emitting light with a predetermined coherence length;
a beam splitter for splitting the light emitted by the light source into a measuring beam and a reference beam;
a reference beam transfer unit designed to convert the reference beam into a plurality of sub-reference beams;
an image data acquisition unit for acquiring image data resulting from a superposition of the sub-reference beams with an object beam, the object beam comprising at least a part of the measuring beam that was scattered and/or reflected by the at least one object; and
an evaluation unit for evaluating the image data acquired by the image data acquisition unit;
wherein the reference beam transfer unit comprises a plurality of spatially separated optical paths, each with different optical lengths, along which the sub-reference beams are guided to the image data acquisition unit.

In the context of the present invention, “detection of at least one object” is understood in particular to mean that the presence of one or more objects, in particular in the surroundings of the measuring device or in the surroundings of a vehicle including the measuring device, is recognized and/or noted. In some embodiments, the “detection or recognition of at least one object” can also mean that shapes and/or contours of one or more objects are recognized, and/or that it is recognized what the object(s) is/are. In other words, “detection of at least one object” can in particular also be understood to mean identifying one or more objects.

In the context of the present invention, an “object” is understood in particular to mean an object that represents an obstacle or a potential danger in road traffic or ongoing site work. The object can therefore be an obstacle or a participant in road traffic, for example. For example, the object can be a construction site, a roadblock, an unwanted object on the road or terrain, a tree, a house, or a vehicle (e.g. car, truck, motorcycle, scooter, bicycle, construction site vehicle, trailer), etc. The vehicle can be, for example, a broken-down vehicle or a moving vehicle (in particular a vehicle in front). The object might equally well be an animal or a person (e.g. a pedestrian or cyclist). The object can be static (i.e. at rest) or dynamic (i.e. moving).

An “object distance” is understood in particular to mean the distance of an object from the measuring device, in particular from the detection unit or image acquisition unit of the measuring device. It is understood that the “object distance” can fundamentally also relate to a distance of the object relative to any object that has a fixed and defined distance from the measuring device or its image data acquisition unit. For example, the object distance can relate to a specific part of a vehicle (which includes the measuring device or in which the measuring device is installed), such as a bumper of the vehicle.

The light source is preferably one or more lasers. The light source is preferably designed so that the predetermined coherence length corresponds approximately to the length of a vehicle (e.g. automobile) in which the measuring device is installed. For example, the coherence length can be in the range of 1 to 5 meters.

A “measuring beam” is understood to mean a light beam or light bundle which is intended to hit the at least one object and to be scattered and/or reflected by it. A “reference beam” is understood to mean a light beam or light bundle which is intended to interfere with at least part of the scattered and/or reflected measuring beam (object beam). The reference beam therefore does not hit the at least one object. A “sub-reference beam” is understood to mean a light beam or light bundle which is based on the reference beam or exits the reference beam. In particular, each sub-reference beam represents a specific part of the reference beam in the form of a pulse. In particular, each sub-reference beam corresponds to the reference beam with a limited duration. In addition, the sub-reference beams are directed or guided along different paths by the reference beam transfer unit and are therefore spatially separated from one another. The sub-reference beams can therefore also be referred to as (individual) reference beam pulses.

The “reference beam transfer unit” comprises or is in particular a (quickly) switchable light-guiding system. By “switching” the reference beam transfer unit, which is done e.g. with the help of a galvo scanner, the reference beam can be temporally broken down and transferred into the sub-reference beams. The sub-reference beams or reference beam pulses can be coupled into different channels (in particular optical fibers or optical waveguides) of the reference beam transfer unit. After passing through a specific, individual optical path length, the sub-reference beams or the individual reference beam pulses are coupled out again from the reference beam transfer unit.

The spatially separated “optical paths” are also referred to as “reference channels” in the context of the invention. The reference channels each have a different optical length. The “optical length” is understood to mean the geometric length multiplied by the refractive index of the material in which the beams are guided at the wavelength of the light source. The sub-reference beams or individual reference beam pulses are guided to the image data acquisition unit along the individual optical paths or reference channels. In other words, the reference beam transfer unit is designed to guide the sub-reference beams to the image data acquisition unit using spatially separated optical paths, in such a way that the sub-reference beams undergo different optical path lengths until they are detected at the image data acquisition unit.

The “image data acquisition unit” comprises or is in particular a detection unit designed to detect the sub-reference beams and the object beam. The image data acquired by the image data acquisition unit includes a superposition of the sub-reference beams with the object beam. In particular, the image data acquired by the image data acquisition unit comprises interferometric data and/or holographic data. In other words, the image data acquisition unit is designed in particular to capture an interference image and/or a holographic image. The image data acquired by the image data acquisition unit thus corresponds in particular to a captured interference image and/or a recorded hologram. In particular, the image data acquisition unit comprises a light detector or a light sensor (e.g. a CCD sensor or a CMOS sensor). Preferably, the image data acquisition unit comprises or is a camera, in particular a CCD camera.

The “evaluation unit” is designed to evaluate the image data acquired by the image acquisition unit, in particular one or more interference images and/or holographic images captured by the image acquisition unit. Preferably, the evaluation unit comprises a processor or microprocessor with which computing operations can be carried out. In addition, the “evaluation unit” preferably comprises one or more data storages. In particular, the evaluation unit can comprise a computer. Furthermore, the evaluation unit can comprise a computer-readable storage medium having a code stored thereon, wherein the code, when executed by a processor, causes the processor to execute steps according to the invention. In particular, the evaluation unit can be realized by suitably configured or programmed data processing devices (in particular specialized hardware modules, computers or computer systems, such as computer or data clouds) with corresponding computing units, electronic interfaces, storages and/or data transmission units. The evaluation unit can further comprise at least one, preferably interactive, graphical user interface (GUI), which enables a user to view and/or enter and/or modify data. The evaluation unit can also have suitable interfaces that enable transmission, input and/or reading of data (e.g. distance data and/or contour data of detected objects).

With the help of the present invention, the shortcomings of previous automatic systems for detecting or recognizing objects (such as obstacles and/or other road users) in road traffic, which are particularly pronounced in poor visibility conditions (such as in fog, rain and/or snowfall), can be overcome. In comparison to previously known systems for object detection and/or distance measurement in road traffic, which are primarily based on the evaluation of amplitude and/or frequency modulated signals, rather an interferometric approach is pursued by the detection and evaluation of object and reference beams or their superposition according to the invention. In this way, not only the weather-related influence, but also the disruptive influence of other road users (particularly due to their sensors) can be minimized. This is in particular because the other road users use a different light source, the light of which is not coherent with the light emitted by the light source of the device according to the invention. Since light can basically only interfere with itself, the interference light from other road users only increases the steady component but does not contribute to the interferometric useful signal.

Because the light used has a predetermined coherence length according to the invention, scattering is also suppressed, which has a positive effect on the accuracy and reliability of the detection of an object and/or the distance measurement in particular in poor visibility conditions (such as rain, fog and/or snowfall). This is in particular because due to the predetermined coherence length (e.g. a few meters), the interference-capable measurement range is limited to half the coherence length. If the path lengths are not adjusted, as is the case with scattering particles before and after the interference-capable measurement range, the light scattered by the scattering particles is not registered interferometrically and can therefore be suppressed in a holographic reconstruction, for example.

The fact that, according to the invention, greater accuracy and/or reliability results in poor visibility conditions is in particular because the light backscattered e.g. by raindrops or fog particles interferes much less with a reference beam than e.g. the light backscattered by a vehicle in front or by an obstacle. Since the rain and/or fog drops are transparent and therefore not only scatter but also transmit the light, the influence of the light scattered by the rain drops and/or fog particles is negligibly small, even if the rain drops and/or fog particles are in the interference-capable measurement range. In addition, the raindrops and/or fog particles have a much smaller scattering and/or reflection surface compared to an obstacle or a vehicle in front, so that the proportion of backscattered or backreflected light is correspondingly lower than e.g. for an obstacle or a vehicle in front. Furthermore, image processing routines can advantageously be trained to distinguish a scene with e.g. rain, fog and/or snow particles from a scene with clear object edges (e.g. using an edge filter).

Due to the superimposition or interference of the object beam with the reference beam or sub-reference beams, the light scattered by the object is amplified (interferometric amplification). Thus, according to the invention, only relatively little light is necessary to illuminate the measurement volume. Compared to other measurement methods that require higher light intensity, this has the advantage that scattering is far less problematic. In addition, eye and/or skin safety regulations, which are particularly relevant when using lasers, can be complied with more easily.

The measuring device according to the invention can in principle be used for all types of vehicles. The measuring device according to the invention can be used e.g. for ordinary automobiles but can also be used in more specific areas such as in the construction industry and/or in the rescue service. For example, the measuring device according to the invention can be particularly advantageous for fully automated construction vehicles (such as excavators) or for a fully automated person search and/or for a fully automated rescue operation. In such special areas of application, visibility conditions can be impaired not only due to the weather, but also e.g. due to heavy dust and/or smoke development (e.g. in the event of a fire).

In a preferred embodiment, the reference beam transfer unit has N optical paths, wherein for all n∈{2, 3, 4, . . . , N} the optical length of an n^{th} optical path differs from the optical length of an (n−1)^{th} optical path by the predetermined coherence length. In other words, the optical lengths of two optical paths consecutive in terms of numbering differ by the predetermined coherence length of the light emitted by the light source. For example, the optical length of a second optical path differs from the optical length of a first optical path by the predetermined coherence length. Accordingly, the optical length of a third optical path differs from the optical length of the second optical path by the predetermined coherence length. Accordingly, the optical length of a fourth optical path differs from the optical length of the third optical path by the predetermined coherence length, etc. The optical lengths of any two of the plurality of optical paths thus preferably differ by the predetermined coherence length or by an integer multiple of the predetermined coherence length. In other words, the reference beam transfer unit is designed such that the optical path lengths travelled by the sub-reference beams differ by the predetermined coherence length of the light emitted by the light source or by a multiple of the predetermined coherence length.

In a further preferred embodiment, the plurality of optical paths of the reference beam transfer unit comprises a plurality of optical fibers and/or optical waveguides. In particular, the optical paths of the reference beam transfer unit are optical fibers and/or optical waveguides.

In a further preferred embodiment, the plurality of optical paths comprises a plurality of optical fibers, wherein the reference beam transfer unit comprises scanning optics with which the reference beam can be successively coupled into the optical fibers. In particular, the scanning optics can comprise a galvo scanner with a scanning lens, a MEMS mirror with a scanning lens and/or a polygon mirror. In particular, the scanning optics can be a galvo scanner with a scanning lens, a MEMS mirror with a scanning lens or a polygon mirror.

Alternatively or in addition, the plurality of optical paths comprises a plurality of optical waveguides, wherein the reference beam transfer unit comprises a waveguide system with which the reference beam can be successively coupled into a plurality of optical or light waveguides (“waveguides”) using thermal effects. The waveguides preferably have different lengths adapted to the application and coherence length of the light source. An outcoupling side of the waveguide system preferably has a plurality of outcoupling channels, which are arranged in a preferably hexagonal 2D array. The waveguide system can be produced using two-photon polymerization, for example. By means of such a waveguide system, which works on the principle of a thermo-optical switch (TOS for short), it is possible to convert the reference beam into the sub-reference beams using the thermo-optical effect. A thermo-optical switch is based on the fact that a material also changes its refractive index when the temperature changes. The most studied TOS systems are based on mode interference and use a configuration that basically represents a Mach-Zehnder interferometer. To this end, two waveguides are guided close to each other, which leads to crosstalk, i.e. the mode propagating in one waveguide is partially transmitted into the other. The waveguides now separate again and pass through heating elements, which change the refractive index of the material by a temperature change and thus also the optical path the propagating mode has to travel. When the waveguides are brought together again, constructive or destructive interference occurs, depending on the difference in the optical path length. By specifically manipulating the phase difference, it is now possible to determine in which of the two waveguides the mode propagates further. Further information on the implementation of such a waveguide system can be found in T. Aalto et al.: “Fast thermo-optical switch based on SOI waveguides”, Proceedings of SPIE—The International Society for Optical Engineering—4987, 2003, 10.1117/12.478334.

In a further preferred embodiment, the optical paths or fibers of the reference beam transfer unit each have a mirrored (or reflective) end section. Since the light is reflected on the mirror surface, it passes through the fiber twice. Therefore, in this case, the different optical fiber lengths are preferably matched to one another by half the coherence length.

In a further preferred embodiment, the reference beam transfer unit comprises a multi-channel fiber connector in which the plurality of optical fibers is arranged at least in some areas. A “fiber connector” is understood in particular to mean an element for housing and guiding a large number of fibers.

In a further preferred embodiment, the optical fibers in the fiber connector are arranged such that, in a top view of the fiber connector, end sections of the optical fibers, from which the sub-reference beams exit, are located on the points of a two-dimensional hexagonal grating. Within the scope of the invention, it has been found that a particularly high level of accuracy in object detection and/or distance measurement can be achieved with such an arrangement.

In a further preferred embodiment, the measuring device comprises an optical lens, in particular a collimation lens, which is arranged such (in particular relative to the fiber connector or to an optical axis of the fiber connector) that the sub-reference beams exiting the reference beam transfer unit (or the optical fibers and/or the optical waveguides) impinge on the optical lens and are deflected by it at different angles (hereinafter also referred to as “interference angles”) with respect to an optical axis of the lens. In particular, the optical axis of the fiber connector and the optical axis of the lens are arranged in a manner offset from one another. In this way, the so-called “carrier frequency method” (see below) can be implemented.

In a further preferred embodiment, the coherence length of the light emitted by the light source is in a range of 1 m to 5 m. This range is e.g. advantageous for an application of the present invention in road traffic and in particular in autonomous driving. It is understood, however, that for other applications a range other than the one mentioned above may be advantageous. For example, smaller coherence lengths could be advantageous for mesoscopic applications. It is also noted that basically a light source having a significantly longer coherence length can also be used, namely when only light pulses are used. A pulse duration of a few nanoseconds creates an interference-capable range of a few meters, for example.

In a further preferred embodiment, the light source is designed to emit light with at least two predetermined different wavelengths. In this way, two-or multi-wavelength holography can be performed. The at least two wavelengths can be generated e.g. from at least two different lasers. For reasons of compactness and costs, however, it is advantageous to use only one light source. To this end, for example, by means of an acousto-optical modulator, a change in the wavelength can be caused by a change in frequency, so that holograms of at least two wavelengths can be recorded in a temporally sequential order. Alternatively or in addition, the wavelength can be adjusted by changing the current intensity applied to the light source or laser.

In a further preferred embodiment, the evaluation unit is designed to evaluate one or more interference images acquired by the image acquisition unit and/or one or more (digital) holograms (holographic images) recorded by the image acquisition unit, which result from a superposition of the object beam (detected by the image acquisition unit) with the sub-reference beams (detected by the image acquisition unit).

In a further preferred embodiment, the evaluation unit is designed to determine from the plurality of sub-reference beams the sub-reference beam or sub-reference beams that caused interference or an interference phenomenon or an interference pattern (in particular a destructive and/or constructive interference) with the object beam. In particular, the evaluation unit is designed to determine from the plurality of sub-reference beams the sub-reference beam or sub-reference beams that, after a Fourier transform, preferably a fast Fourier transform (FFT), caused a diffraction order occurring in the Fourier space. The distances to stationary or moving objects can then be deduced from the lengths of the optical paths or reference channels associated with the determined sub-reference beams.

Alternatively or in addition, the evaluation unit is preferably designed to determine at least one object distance on the basis of an interference image resulting from a superposition of the object beam (detected by the image acquisition unit) with the sub-reference beams (detected by the image acquisition unit). To this end, the predetermined coherence length is preferably also taken into account. Taking into account the predetermined coherence length, one can specify in particular a possible deviation of the determined distance from the actual distance. In particular, a possible deviation of the determined distance from the actual distance corresponds to half the predetermined coherence length.

Alternatively or in addition, the evaluation unit is preferably designed to perform a computational (or numerical) reconstruction of a digital hologram. A computational reconstruction of digital holograms comprises in particular the following steps:
carrying out a Fourier transform (preferably using a Fast Fourier Transform algorithm) of the recorded digital hologram;
carrying out filtering to remove unwanted reconstructions (conjugate reconstruction, zero-order diffraction); and
carrying out an inverse Fourier transform (preferably using a Fast Fourier Transform algorithm) on the filtered data.

In particular, the reconstruction makes it possible to obtain the amplitude and phase of an object wavefront. Since the amplitude and phase of the reconstructed wavefront provide an image of the objects, it is advantageously possible to obtain information about the dimensions and positions of the objects (such as cars, pedestrians, animals, etc.). The phase information also offers the possibility of image focusing. Since the computational reconstruction of digital holograms is fundamentally known to those skilled in the art, no further explanations will be given in this regard within the scope of the present invention.

Alternatively or in addition, the evaluation unit is preferably designed to determine a contour of the at least one object on the basis of a digital hologram, which results from a superposition of the object beam (detected by the image acquisition unit) with the sub-reference beams (detected by the image acquisition unit).

A further independent aspect for achieving the object relates to a vehicle including a measuring device according to the invention or equipped with a measuring device according to the invention. The vehicle can be any vehicle, for example an automobile (in particular a passenger car), a motorcycle, a truck, a construction vehicle, a construction site vehicle, an emergency vehicle, an agricultural vehicle, etc.

A further independent aspect for achieving the object relates to a method for detecting an object and/or for determining at least one object distance, in particular in road traffic, comprising the steps of:
providing a measuring device according to the invention and/or a vehicle according to the invention; and
evaluating an interference image and/or a digital hologram (or holographic image), which results from superimposing the object beam (detected by the image acquisition unit) with the sub-reference beams (detected by the image acquisition unit).

In a preferred embodiment, the method comprises the following steps:
carrying out a Fourier transform, in particular a fast Fourier transform (FFT), in order to transfer the image data acquired by the image data acquisition unit (or an image acquired by the image acquisition unit) into the Fourier space;
based on the result of the Fourier transform carried out, determining at least one sub-reference beam that caused destructive and/or constructive interference with the object beam;
determining the optical path length traveled by the at least one interfering sub-reference beam by identifying the at least one optical path along which the at least one interfering sub-reference beam was guided to the image data acquisition unit; and
determining at least one object distance, in particular an object distance range, based on the at least one determined optical path length and preferably also based on the predetermined coherence length of the light emitted by the light source.

Alternatively or in addition, the at least one object distance can be determined in particular on the basis of at least one position in the spatial frequency space represented or determined by a Fourier transform. The position can be assigned to an interference angle of the corresponding reference beam or sub-reference beam. The interference angle is defined by the inclination of the reference beam or sub-reference beam to the object beam. In order for both beams (i.e. the reference beam or sub-referencebeam on the one hand and the object beam on the other) to interfere with one another, their optical path lengths must be matched to one another. The optical path length Ln results from the known geometric path length L to Lₙ=L*n, where n denotes the refractive index.

In particular, the distances of (stationary or moving) objects relative to the (stationary or moving) measuring device or to the image data acquisition unit of the (stationary or moving) measuring device can be determined from the lengths of the optical paths or reference channels associated with the determined sub-reference beams.

In a further preferred embodiment, the method comprises the following steps:
carrying out a computational (or numerical) reconstruction of a digital hologram recorded by the image data acquisition unit; and
determining at least one dimension and/or at least one contour of the at least one object on the basis of the reconstruction carried out.

In a further preferred embodiment, the light source of the measuring device is designed to emit light with at least two predetermined different wavelengths, with methods of multi-wavelength holography being used to determine the at least one dimension and/or at least one contour of the at least one object. If two predetermined wavelengths are used, the methods of two-wavelength holography are used in particular.

It is understood that the features mentioned above and those to be explained below can be used not only in the combination specified in each case, but also alone or in other combinations, without departing from the scope of the present invention.

The statements made above or below regarding the embodiments of the first aspect also apply to the further independent aspects mentioned above and in particular to related preferred embodiments. In particular, the statements made above and below regarding the embodiments of the other independent aspects also apply to an independent aspect of the present invention and to related preferred embodiments.

Individual embodiments for achieving the object will be exemplarily described below with reference to the figures. Some of the individual embodiments described include features that are not absolutely necessary to carry out the claimed subject matter, but which provide desired properties in certain applications. Embodiments that do not include all the features of the embodiments described below are also to be considered as being comprised by the technical teaching described. Furthermore, in order to avoid unnecessary repetition, certain features will only be mentioned in relation to individual embodiments described below. It should be noted that the individual embodiments are therefore not only to be viewed individually, but also in conjunction. Based on this overview, the person skilled in the art will recognize that individual embodiments can also be modified by incorporating individual or multiple features of other embodiments. It is noted that a systematic combination of the individual embodiments with one or more features described in relation to other embodiments may be desirable and useful and is therefore to be considered as being comprised by the description.

### BRIEF DESCRIPTION OF THE DRAWINGS

FIG. 1 shows a schematic sketch for illustrating an exemplary problem of the present invention;

FIG. 2 shows a schematic sketch for illustrating a principle of the present invention according to an example;

FIG. 3 shows a schematic sketch of a measuring device 100 according to a preferred embodiment of the invention;

FIG. 4 shows a further schematic sketch of a measuring device 100 according to a preferred embodiment of the invention;

FIG. 5 shows a schematic sketch for generating sub-reference beams according to an exemplary embodiment of the invention;

FIG. 6 shows a schematic sketch for evaluating acquired image data according to an exemplary embodiment of the invention;

FIG. 7 shows an enlarged view of a section of FIG. 6 with further details;

FIG. 8 shows a schematic sketch for illustrating a principle of the present invention according to a further example or a preferred embodiment;

FIG. 9 shows a schematic sketch of a measuring device 100 according to a further preferred embodiment of the invention;

FIG. 10 shows a schematic sketch of a measuring device 100 according to a further preferred embodiment of the invention.

### DETAILED DESCRIPTION OF THE DRAWINGS

In the context of the present description, a vehicle equipped with a measuring device is also referred to as a measuring vehicle for short. A vehicle to be detected by a measuring device or the measuring vehicle is also referred to as a target vehicle or generally as an object.

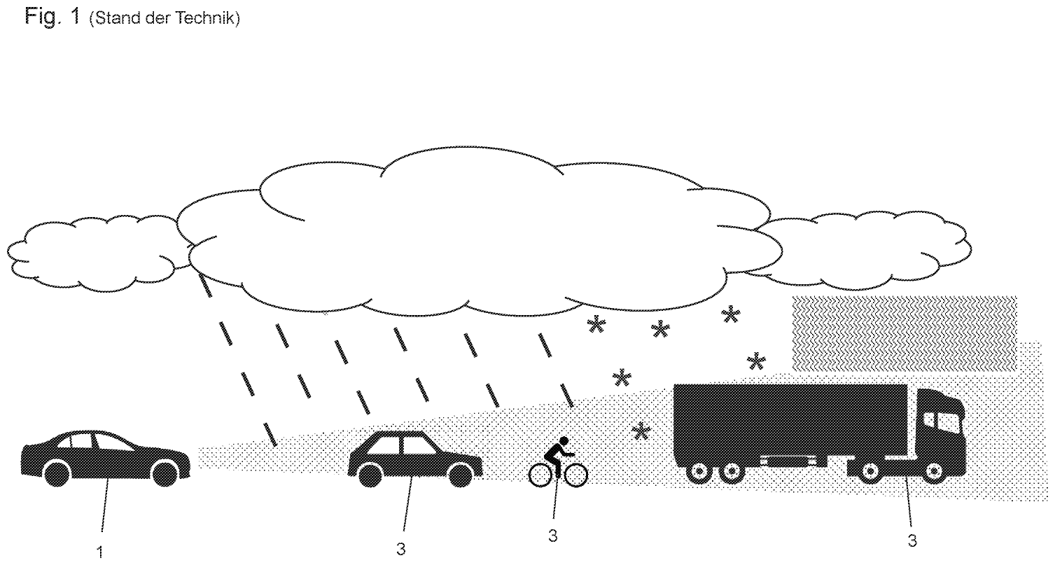

FIG. 1 shows a schematic sketch for illustrating an exemplary problem of the present invention. A measuring vehicle 1, for example an automobile, by means of a measuring device with which the measuring vehicle 1 is equipped, is to automatically detect or recognize one or more target vehicles or objects 3, in particular one or more vehicles in front (such as another automobile, a cyclist and/or a truck, as shown in FIG. 1) and/or other objects (not shown in FIG. 1) such as obstacles on the road, even in poor visibility conditions (e.g. precipitation, fog, smoke, etc.) and/or determine a distance or distance information of the detected objects 3 to the measuring vehicle 1. In other words, the “scene” in front of the measuring vehicle 1 in particular is to be measured. Preferably, the scene in front of the measuring vehicle 1 is to be measured three-dimensionally (e.g. in the form of a 2D image and additional distance information).

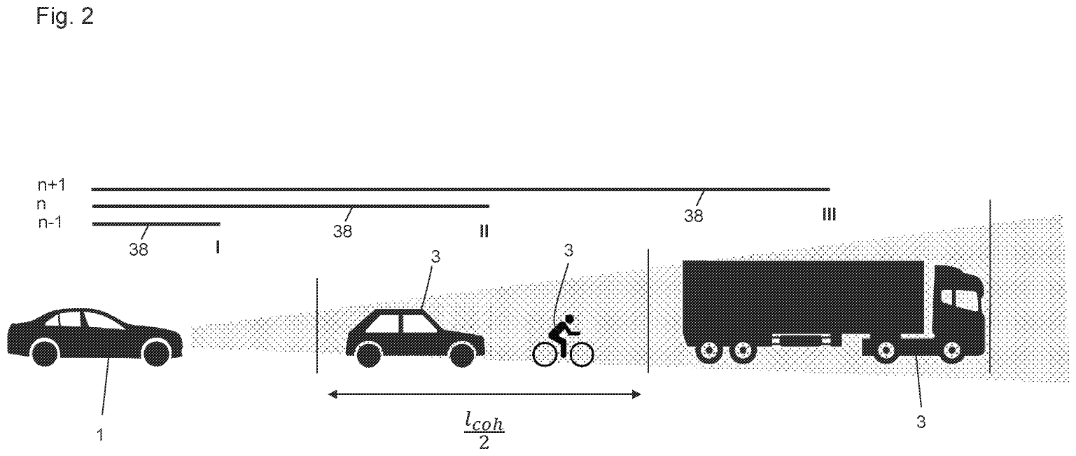

FIG. 2 shows a schematic sketch for illustrating the principle underlying the invention according to an example. As in FIG. 1, a measuring vehicle 1 and three target vehicles 3 driving in front are shown in FIG. 2 as well. A three-dimensional measurement of the scene in front of the measuring vehicle 1 is carried out using the optical coherence tomography method based on “coherence gating”. As can be seen in FIG. 2, the area or scene in front of the measuring vehicle 1 is divided into different measurement sections (in the example shown in FIG. 2, measurement section I, measurement section II and measurement section III). Each measurement section has a different predefined distance from the measuring vehicle 1. The individual measurement sections each have an axial extent that corresponds to half the coherence length I_{coh}/2 of a light source used for the measurement. Furthermore, three different optical paths or reference channels 38, which have different lengths, are indicated in FIG. 2, namely an (n−1)^{th} reference channel, an n^{th} reference channel, and an (n+1)^{th} reference channel. The optical paths or reference channels 38 can in particular be realized by optical fibers, which is why they can also be referred to as fiber channels in this case. The optical path length of a reference channel 38 indicates the axial distance of the measurement section in which an object 3 can be recognized by means of interference. Thus, each reference channel 38 is assigned exactly one measurement section or measurement area. In the example of FIG. 2, the (n−1)^{th} reference channel is assigned to the measurement section I, the n^{th} reference channel is assigned to the measurement section II, and the (n+1)^{th} reference channel is assigned to the measurement section III. By evaluating an acquired interference image, it can be determined which of the reference channels 38 contributed to interference. By assigning each reference channel 38 to a measurement section, the measurement section in which an object 3 is located at the time of the measurement can therefore also be determined. This is in particular because an interference phenomenon only occurs when the path length difference between a reference beam and a measurement or object beam is less than or equal to the predetermined (finite) coherence length I_{coh} of the light source used for the measurement.

As already mentioned, the invention is based, among other things, on the principle of optical coherence tomography (OCT). Optical coherence tomography is commonly used to measure organic substances such as skin. The resolution is a few μm. This measurement technique is often used on the eye. It creates images of the back of the eye in order to diagnose eye diseases. In optical coherence tomography, a light beam is split into two parts. One part of the light beam is directed onto the sample (e.g. the eye) and later interferes with the second part of the light beam. Within the scope of the present invention, this method was modified so that objects can be recognized and/or distance measurements can be made in road traffic. Here, an axial resolution of a few meters can be achieved. The decisive advantage of the present invention is that the influence of e.g. fog and/or other scattering sources located between the detector of the measuring device and the object on the measurement is smaller compared to other methods (e.g. Lidar).

Within the scope of the present invention, it was recognized that the so-called “Time Domain OCT” is particularly suitable for applications in road traffic, which in the conventional implementation is usually based on the use of a mirror mounted on a piezo actuator in the reference arm, with which the narrow-band interference-capable range, which can be estimated with the equation

$$Δ z \sim \frac{{λ}^{2}}{Δ λ}$$

is tuned axially. In the above equation, Δz denotes the axial resolution, λ the central wavelength, and Δλ the full spectral bandwidth at half height of the spectrum (FWHM). In this way different layers of the volume-scattering medium can be addressed and isolated from layers above and below by interferometric signal evaluation. OCT is therefore also referred to as an optical thin section method because, as in histology of volume-scattering media (mostly biological tissue), it generates digital axially resolved thin sections in a computer-aided way, although the sample is not damaged/cut up, as is conventionally the case when thin sections are produced using a microtome.

Instead of a point sensor, as is used in conventional OCT, an area sensor is preferably used within the scope of the present invention, so that the lateral dimension of the interference-capable range can be acquired in just one recording. This approach offers certain advantages in particular compared to the “Frequency Domain OCT”, which can in principle also be used for the decomposition into different axial sections of volume-scattering media. Here, as in conventional Time Domain OCT, either a light source that is usually spectrally broadband is used to determine the transit time and thus the distance from the recording of the spectral interference (“Spectral Domain OCT”) in accordance with the Wiener-Khintchen theorem, or a spectrally tunable light source is used (“Swept Source” OCT), so that in principle it is also possible to use an area sensor here. However, in this case, many wavelengths would have to be tuned in order to then calculate the corresponding depth-resolved levels. The depth resolution or the axial extension of the measurement section results from the spectral broadband of the light source (“Spectral Domain OCT”) or from the spectrally tuned wavelength range (“Swept Source OCT”). The measurement range that can be axially resolved depends on the spectral resolution of the spectrometer (“Spectral Domain OCT”) or the spectral broadband of the individual wavelengths (“Swept-Source OCT”).

The measurement method of the so-called “Frequency Modulated Continuous Wave” (FMCW) Lidar substantially corresponds to the implementation of the “Swept-Source OCT” for macroscopic distance measurement of typically up to 100 m. Therefore, a spectrally very narrow-band light source must be used, which then also is tuned in very fine spectral steps (in the sub-picometer range). In addition, the sequential approach of “Frequency Domain OCT” has the disadvantage that it can only be used for volume-scattering media with stationary scatterers and that a large number of interferograms with different wavelengths must first be recorded. The reconstruction shows the entire measurement volume with the different measurement sections. Within the scope of the invention, however, it was recognized that this is not necessary for an application in road traffic, since usually only a few measurement sections, namely those in which objects to be detected are located, are relevant. In particular, the inventors found that due to the potential to obtain the relevant depth information in just one recording, “Time Domain OCT”, in particular in conjunction with a camera, has significant advantages over “Frequency Domain OCT” in the application of dynamic volume-scattering media with time-varying scatterers. Furthermore, the inventors found that the reference arm cannot be moved in a motorized manner, as is conventional, in order to be able to realize the “Time Domain OCT” for distance measurement in the range of 100 m in a realistic time frame.

However, within the scope of the invention it was found that, via scanning optics, the reference beam can preferably be coupled into a fiber connector with many single-mode and/or single-mode polarization-maintaining fibers in very rapid succession (kHz). The fiber lengths are preferably matched to one another such that the optical length difference (=geometric length*refractive index at the laser wavelength) between the n^{th} and (n−1)^{th} fiber and between the n^{th} and (n+1)^{th} fiber corresponds to the coherence length of the light source used. In this way, the entire measurement range can be scanned completely, see FIG. 2.

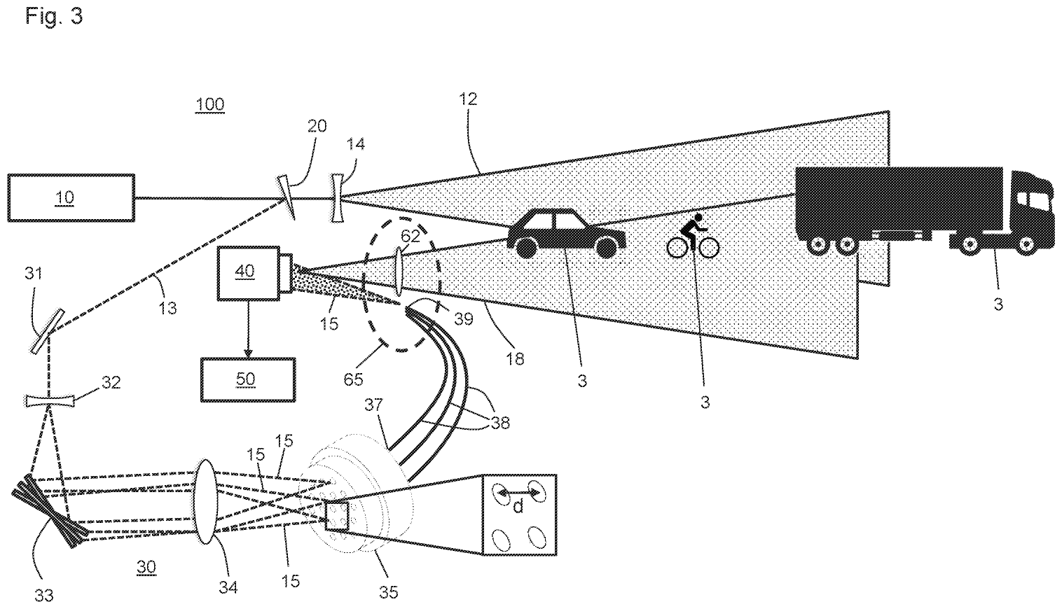

FIG. 3 shows a schematic sketch of a measuring device 100 according to a preferred embodiment of the invention. By means of the measuring device 100, at least one object 3 can be detected and its distance from the measuring device 100, in particular from an image data acquisition device 40 of the measuring device 100, can be determined. The measuring device 100 has a light source or a laser 10 for emitting light with a predetermined coherence length. Furthermore, the measuring device 100 has a beam splitter 20 for dividing the light emitted by the light source 10 into a measuring beam 12 and a reference beam 13. The measuring beam 12 is expanded using a converging lens 14. Furthermore, the measuring device 100 has a reference beam transfer unit 30, which is designed to convert the reference beam 13 into a plurality of sub-reference beams 15. By means of the image data acquisition unit or camera 40, image data that results from a superposition of the sub-reference beams 15 with an object beam 18 can be acquired. In particular, interference images and/or holograms can be recorded with the image data acquisition unit or camera 40. They/It can finally be evaluated with the help of an evaluation unit (50). The measuring beam 12 is scattered and/or reflected by the at least one object 3. This scattered and/or reflected measuring beam is referred to as object beam 18 in the context of this description.

In the embodiment in FIG. 3, the reference beam transfer unit 30 comprises a mirror 31 for deflecting the reference beam 13 and a scattering lens 32 with which the reference beam 13 is expanded. Moreover, the reference beam transfer unit 30 comprises scanning optics, which e.g. comprises a galvo scanner 33 and a scanning lens 34. With the galvo scanner 33, the reference beam 13 can be coupled into single-mode fibers of different lengths, for example. However, the scanning optics can just as well comprise e.g. a MEMS mirror with a scanning lens and/or a polygon mirror (not shown in FIG. 3). The reference beam 13 scattered by the scattering lens 32 hits the scanning optics or the galvo scanner 33 and is finally converted into a plurality of sub-reference beams 15 via a scanning lens 34. The sub-reference beams 15 are successively coupled into the openings of a fiber connector 35 of the reference beam transfer unit 30. In particular, each of the sub-reference beams 15 is coupled into a different opening of the fiber connector 35. The openings of the fiber connector 35 are preferably arranged at the points of a two-dimensional hexagonal grating. A distance d between two openings of the fiber connector 35 can be e.g. approximately 300 μm (see the enlargement of four exemplary openings of the fiber connector shown in FIG. 3). An input or input section 37 of an optical path or an optical fiber 38 is arranged in each opening of the fiber connector 35. Each sub-reference beam 15 is thus coupled into a separate optical path or into a separate optical fiber 38. The separate (i.e. spatially separated) optical paths or fibers 38 (in particular single-mode fibers) each have a different length (in particular a different optical length). Outputs or output sections 39 of the optical fibers 38 are arranged in the pupil plane of an imaging optics 65 (in particular a lens). It should be noted at this point that, according to an alternative embodiment, the optical paths 38 can also be designed as waveguides, for example. By means of the optical paths 38, the sub-reference beams 15 are guided to the image data acquisition unit 40.

The individual sub-reference beams 15 exiting the optical fibers 38, which have each traveled a different path length, are finally detected by the image data acquisition unit (detection unit) or camera 40. In addition, the object beam 18 is also acquired/imaged by the image data acquisition unit 40 using a lens 62. The lens 62 is in particular an imaging lens in the object beam path, so that an image of the object is reproduced on the sensor. The sub-reference beams 15 and the object beam 18 are superimposed and generate an interference image and/or hologram, which is recorded by the image data acquisition unit 40.

With the present invention, in particular, the positions in space of moving objects or stationary obstacles can be determined relative to one another, in particular by reconstruction using digital holography and using the principle of coherent optical tomography.

By using a finite number of reference beams of different lengths, it is possible to acquire digital holographic images corresponding to different surfaces of objects observed in space within the limits of the coherence length. The entire measurement range can be broken down into interference-capable sub-ranges, with adjacent sub-ranges having a certain axial overlap with one another. For the rapid sampling of all sub-ranges, quickly switchable light-guiding systems are realized, for example by using single-mode fibers of different lengths, which are designed such that only a certain sub-range can be addressed interferometrically for each fiber.

When designing the fiber lengths, both the optical light path due to the refractive index of the fiber and the double path traveled by the object beam necessary for the interference must be taken into account. The fibers are preferably married/associated on both sides in a common fiber connector. The different channels can be tuned very quickly using scanner optics (galvo scanner with scanning lens, MEMS mirror with scanning lens, polygon mirror, etc.).

At the other end of the multi-channel fiber connector (or alternatively the waveguide system) a lens is preferably arranged, which is preferably positioned so that the fiber-emitted light is collimated. Due to the different lateral positions of the fibers of different lengths in the fiber connector, different angles with respect to the optical axis arise during collimation. Here, the fiber connector is preferably laterally decentered with respect to the optical axis of the lens such that an angle with respect to the optical axis is formed for the emitted light of all fibers. Fibers that ensure the interference capability of adjacent measurement ranges in the axial scan are preferably arranged in the fiber connector such that the emitted and then preferably collimated light of both beams has a maximum angular offset from one another.

During a single camera recording (hologram), the kHz-capable high-speed scanner passes through all fibers or waveguides, and thus all interference-capable path lengths.

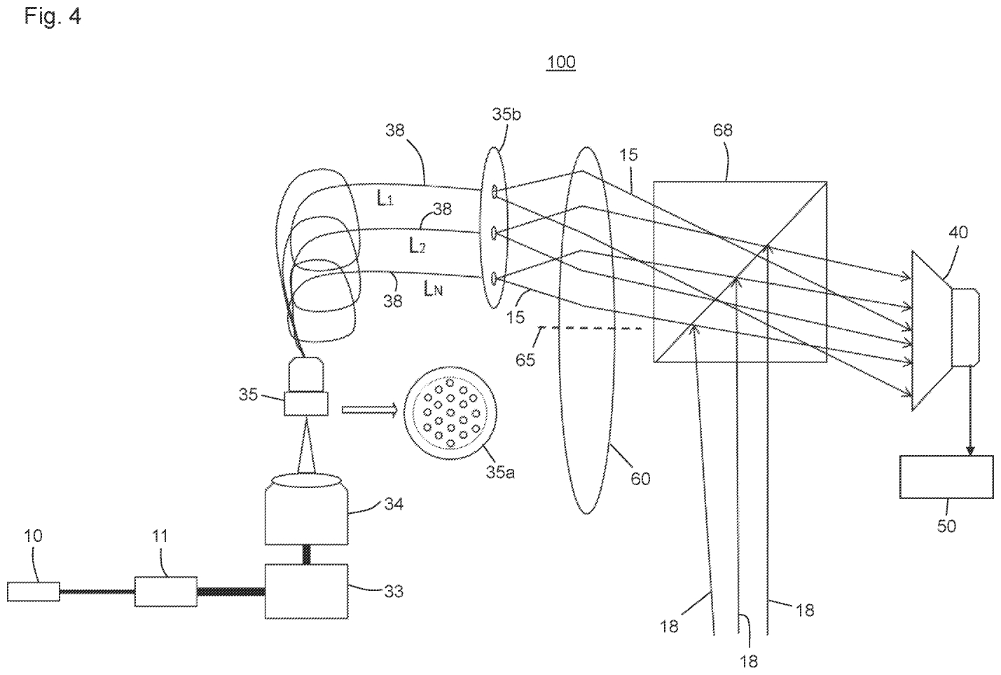

FIG. 4 shows a further schematic sketch of a measuring device 100 according to a preferred embodiment of the invention. Coherent light from a light source 10 is bundled by a collimator 11 and reaches a scanning lens or an F-theta lens 34 via a galvo scanner 33. The light is finally guided into a fiber connector 35 through light fibers 38 that have a different length each. As illustrated in FIG. 4, the optical fibers 38 are arranged in the fiber connector 35 such that in a top view of the fiber connector 35 or a fiber connector input 35a, input sections of the optical fibers, into which sub-reference beams 15 enter, are located on the points of a two-dimensional hexagonal grating. Accordingly, the optical fibers 38 are arranged in the fiber connector 35 such that, in a top view of a fiber connector output 35b, end sections of the optical fibers 38, from which the sub-reference beams 15 exit, are located on the points of a two-dimensional hexagonal grating (in FIG. 4 not visible, since for the sake of simplicity only three output openings of the fiber connector 35 are shown). In the example of FIG. 4, the fiber connector 35 comprises a total of 19 openings, so that 19 optical fibers 38 are arranged in the fiber connector 35. As already mentioned, only three of the total 19 fiber outputs are shown exemplarily in FIG. 4.

The measuring device 100 of FIG. 4 further comprises an optical lens 60 arranged such that the sub-reference beams 15 exiting the fiber connector 35 or the fiber connector output 35b hit the optical lens 60 and are deflected by it at different angles with respect to an optical axis 65 of the lens 60. The lens 60 is in particular a so-called Fourier lens. The fiber ends 35b are located at a focal length distance from the lens 60, so that the corresponding lateral position of each fiber end is translated into an inclined, collimated beam path after passing through the lens 60. By means of a beam splitter 68, the sub-reference beams on the one hand and one or more object beams 18 on the other hand are directed to the detection unit or image data acquisition unit 40. The acquired image data can then be evaluated via the evaluation unit 50 (in particular a computer). In particular the sub-reference beams that have resulted in interference or an interference signal with the object beam 18 can be determined from the plurality of sub-reference beams 15. Alternatively or in addition, at least one object distance can be determined on the basis of an interference image, which results from superimposing the object beam 18 with the sub-reference beams 15. Preferably, the predetermined coherence length of the light source 10 is also taken into account in order to indicate a possible deviation from the actual distance. Alternatively or in addition, a computational reconstruction of a digital hologram is carried out. Alternatively or in addition, contours and/or dimensions of the at least one object 3 can be determined on the basis of a digital hologram, which results from superimposing the object beam 18 with the sub-reference beams 15.

Due to the offset of the respective light fibers 38 with respect to the optical axis 65 of the lens 60 shown in FIG. 4, the images of each light fiber 38 are separated from one another after a Fourier transform. Since approximately only 10% of the fibers have an interference signal, there is advantageously no or only a slight overlap of the respective measurements in Fourier space. Another advantage of the structure is, in particular, that all fibers 38 and thus all interference-capable wavelengths can be measured in a single camera recording.

Within a single recording with a camera frame rate of typically 20 fps (fps=images per second), all fibers 38 are preferably passed through with the scanning optics (e.g. with the galvo scanner 33). Since the main signal, for example in the situation of autonomous driving, usually only comes from an object that is located in a measurement section or in the transition area of two measurement sections, there is only a coherent superposition (formation of an interference pattern) or in the transition area of two interference patterns within one recording. In the latter case, the information content of both interference patterns can be separated from one another due to the very different carrier frequency angles in Fourier space and can therefore be reconstructed separately. This just means that the light guided in the appropriately adapted reference fibers contributes to the interference. The light coming from the other, non-path-length-matched reference fibers during recording does not contribute to the interference, but only to the steady component. It is advantageous if the positions of adjacent fibers 38 in the fiber connector are far apart from one another, so that strongly detuned carrier frequencies are formed on the sensor 40, which can be filtered and thus separated using 2D Fourier transform.

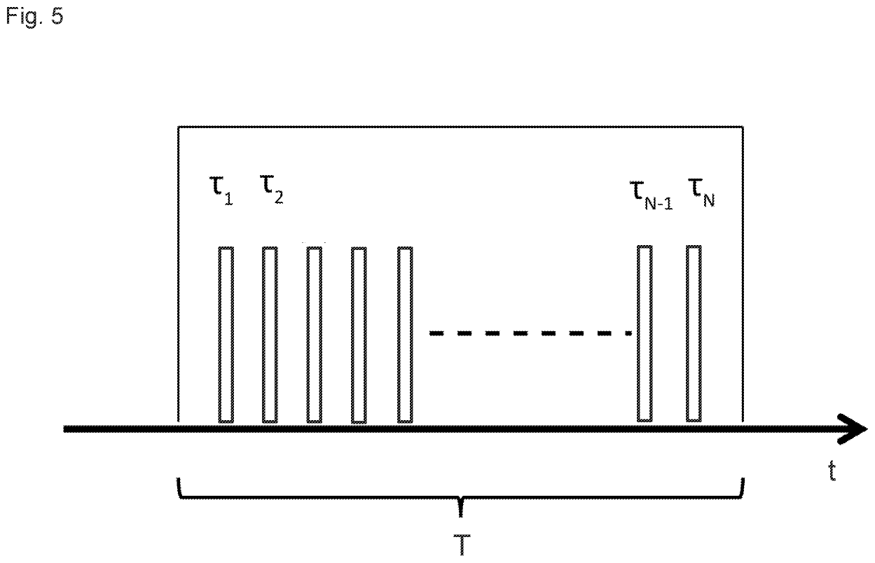

FIG. 5 shows a schematic sketch of the time sequence of the sub-reference beams according to an exemplary embodiment of the invention. In particular, FIG. 5 shows a holographic individual recording with registration of all possible object distances in the measurement range, which are divided into sub-sections according to the transmission of the light through the fibers 1 to N, within a camera frame. The duration of an image recording (camera frame duration) is denoted by T in FIG. 5. The bars shown in FIG. 5 represent light pulses, where τ denotes the illumination time by a single fiber. Preferably, all light pulses τ₁, τ₂, . . . τ_{N} each have the same illumination duration, i.e. τ₁=τ₂= . . . =τ_{N}, where N denotes the number of optical fibers. The light or the light pulses are coupled into the individual fibers one after the other using scanning optics. Preferably, for example, fiber 2 is shorter than fiber 1. And in general, fiber n (with n>1) is preferably shorter than each of fibers 1 to (n−1). In this way, the sub-reference beams, which are transported through the different fibers, arrive at the detector substantially simultaneously (or with only a small time delay). Although the impact of the sub-reference beams on the detector or on the image data acquisition unit can be slightly offset in time, this time offset is not significant relative to the long integration time of the camera sensor (usually several milliseconds).

A digital reconstruction of a recorded hologram is carried out by applying a 2D Fourier transform and thus transferring the registered interference into the spatial frequency range. In this case, in the spatial frequency range, it is possible to separate the different axial measurement sections of the measuring volume, which are interferometrically coded via the fiber lengths and the corresponding angle of incidence of the reference beam.

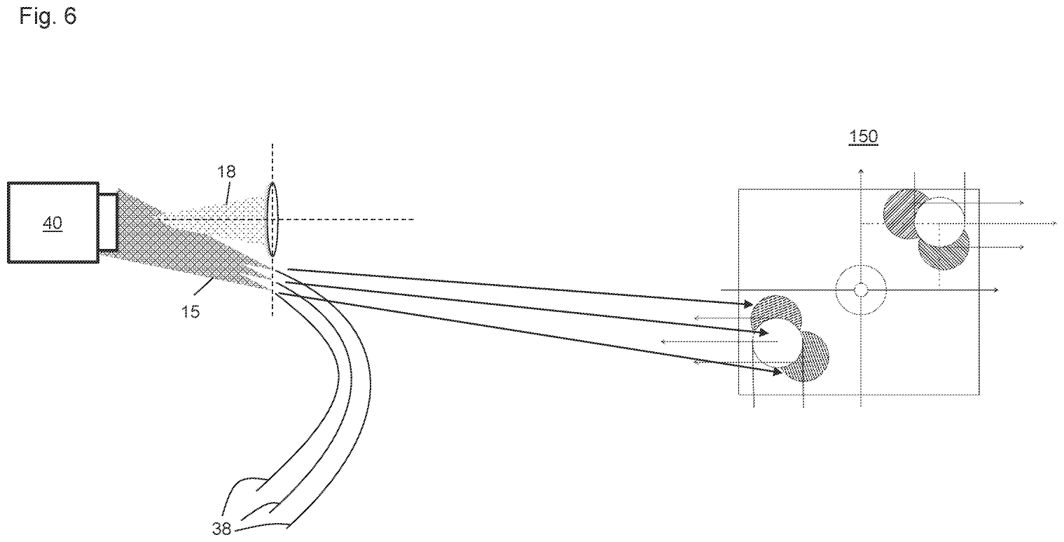

FIG. 6 shows a schematic sketch for evaluating acquired image data using a Fourier transform. As indicated in FIG. 6, the individual optical paths 38 can be represented separately from one another in the Fourier space 150 (right part of FIG. 6). The arrows shown in FIG. 6 indicate the different frequency ranges or times that occur when scanning through the different fiber lengths, so that different axial measurement sections can be acquired interferometrically. The position of the end facet of an optical path or a fiber 38 in the pupil plane determines the position of the diffraction order in the spatial frequency space. The end facets can be arranged using a priori knowledge such that several or all channels are scanned within a camera frame and a clear assignment of the object signal to a specific channel is still possible.

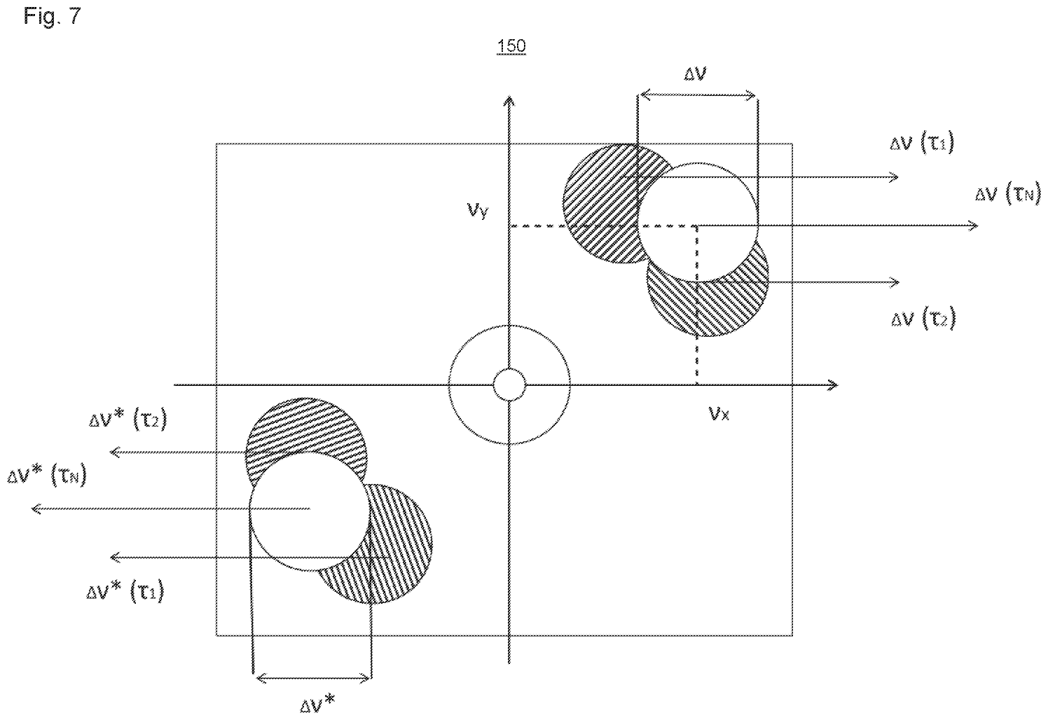

In FIG. 7, the right part of FIG. 6, which shows an exemplary representation of an interference image based on three reference channels or sub-reference beams in Fourier space 150, is enlarged and shown with further details. In particular, FIG. 7 shows exemplarily the corresponding signals for three reference fibers after application of a 2D Fourier transform, which are reproduced at different angles and corresponding different carrier frequencies of the resulting interference pattern. The coordinate axes indicate the spatial frequencies in the x and y directions (unit: lp/mm). The circles illustrate the frequency ranges shown for three measurement sections in Fourier space 150, where Δv represents a frequency width. The recorded interference image consisting of reference and object beams creates a sinusoidal intensity distribution. The Fourier transform of the sine results in positive and negative frequency components, which are identical in content, apart from the phase conjugation. An asterisk means that in this case it is the conjugate complex frequency range.

The interference signals of the different fibers recorded in the interference image or hologram are encoded by different interference angles so that they can be separated from each other after the 2D Fourier transform due to the different spatial frequencies. “Interference angle” refers in particular to the angle of a light beam that has exited a fiber with respect to the optical axis.

The frequency step size can be calculated as follows:

$$δ v = \frac{Z Δ x}{λ fM} ,$$

with Z the number of pixels along a dimension, Δx the corresponding pixel size, λ the wavelength, and M the imaging scale of the optical system used to generate the image plane hologram.

The maximum recorded spatial frequency is then calculated as:

$${v}_{max} = \frac{{Z}^{2} Δ x}{2 λ fM}$$

The critical angle νₘₐₓ, which corresponds to the maximum spatial frequency, is given according to the Nyquist criterion by the equation:

$${γ}_{max} = a sin ( \frac{λ}{2 Δ x} )$$

Due to the small critical angle of, for example, 3° with typical input values of □λ=0.5 μm and Δx=5 μm, the equation can be simplified and integrated into the equation above so that

$${v}_{max} = \frac{{Z}^{2}}{{γ}_{max} fM}$$

In particular, the fact is exploited that, at least in road traffic, the vehicle facing the measuring vehicle obscures the vehicles behind it that could also be in the measurement area, so that these vehicles can hardly be expected to make a significant contribution to the measuring signal. Thus, the object information represented in the spatial frequencies in the Fourier space 150 (space bandwidth product: product of spatial resolution and field size) can be optimized or maximized with regard to the bandwidth. The field size refers to the lateral extension of the measurement section limited in z. For optimization in the sense of a large space bandwidth product, it should be ensured that the object information of neighboring measurement sections in Fourier space 150 does not overlap but is furthest apart from each other. However, the theoretically possible overlap of the object information of measurement areas that are far apart can be excluded, so that the available frequency range in Fourier space 150 is maximized.

The field of application of the invention mostly relates to the detection of objects (obstacles, road users in front, etc.) in poor or difficult visibility conditions in road traffic. Experience has shown that the obstacles are large surface scattering surfaces (e.g. the body of a car in front), so that the majority of the light is reflected and/or scattered by this surface. Other measurement sections that are even further away cannot be recorded interferometrically because the light cannot pass through the body. On the other hand, measurement sections that are located in front of the obstacle are interspersed with scattering particles such as those found in fog, dust, rain, etc. In these measurement sections, significantly less light is scattered and/or reflected toward the camera than is the case with the measurement object. It can also happen that the object to be detected is in the overlapping area of two adjacent measurement sections. A strong interference signal would then be detected from these two measurement sections. However, the other sections where there is no object would not have a significant contribution to the interferometric signal. Therefore, the overlap of the object information in the Fourier space 150 of distant measurement sections is virtually impossible for this field of application. This results in a reconstruction with improved imaging quality (improved spatial resolution with the same measuring field size).

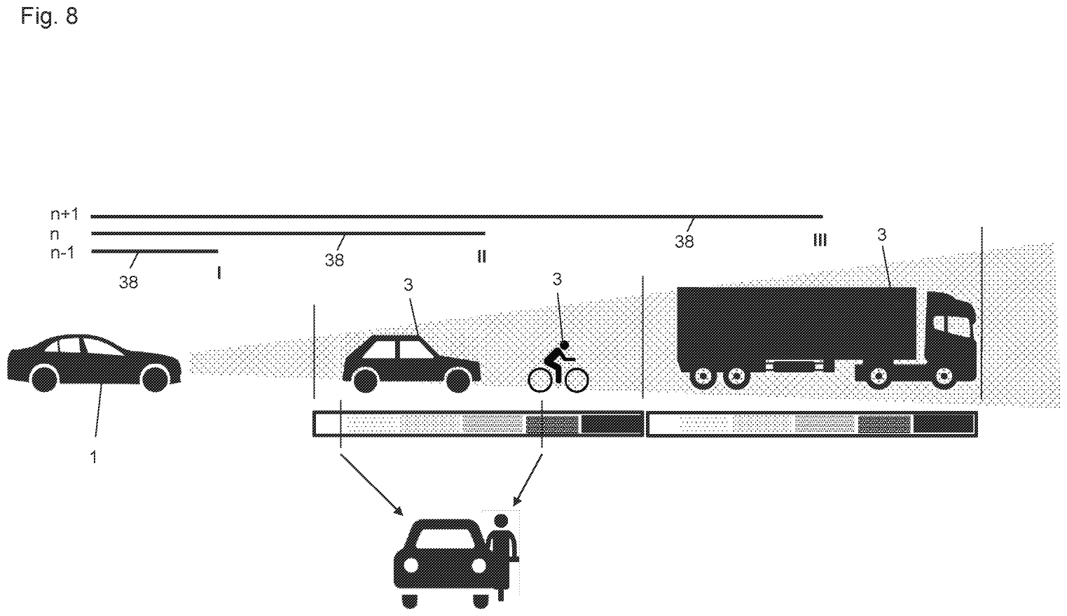

FIG. 8 shows a schematic sketch for illustrating a principle of the present invention according to a further example or a further preferred embodiment. In this embodiment, two or more different wavelengths are used for the measurement, allowing fine tuning to be performed. In particular, the partial measurement range of an individual channel can be additionally measured using two-or multi-wavelength holography. The principle is based on the generation of a synthetic wave or wavelength, calculated from two holograms with slightly different optical frequencies. Comparable to acoustic beats, a wave with a significantly longer wavelength (up to the meter range) can be generated. The synthetic wavelength is chosen such that it corresponds to the length of the partial measurement range. In particular, the object distances within the partial measurement range can be determined from the phase position of the synthetic wave. By evaluating the phase information, when using at least two adjacent wavelengths, the measurement section determined by the coherence length can be resolved even more finely and the contour of the object can be reconstructed.

Here, the spectral distance of the two wavelengths is preferably to be chosen such that the measurement range

$${z}_{mess} = \frac{{λ}_{syn}}{2}$$

resulting from the synthetic wavelength λ_{syn} is smaller than or equal to the measurement section caused by the coherence length. The synthetic wavelength is calculated from λ_{syn}=(λ₁·λ₂)/(|λ₁−λ₂|) with λ₁ and λ₂ the two wavelengths used. Because both wavelengths are very close to one another and preferably illuminate the measurement volume from the same direction, the light of both wavelengths is subject to similar scattering events. By subtracting the holographically reconstructed phase of both wavelengths, the influence of multiple scattering in the volume can be further reduced and visibility can be improved. Moreover, the contour of the obstacle where most of the light is reflected and/or scattered can be reconstructed with a modulation of half the synthetic wavelength.

For example, in the widely used embodiment of the image plane hologram, the corresponding information is first filtered in Fourier space. Using an inverse Fourier transform you get back to the image plane, wherein now the complex information including the amplitude and phase is available. This step is carried out for both wavelengths. The corresponding phase information of both wavelengths is then subtracted from each other. The phase image generated corresponds to that of a synthetic wavelength, which is significantly larger.

The “reconstructed phase” of the respective wavelength corresponds to the height information of the object. For height levels less than half the wavelength used, the height of the object can be determined directly from the phase image of a single wavelength. For example, at a wavelength of 1064 nm, the object should have a maximum height of 532 nm. This would then correspond to a phase value of 2π, whereas the height level of zero could be equated with a phase value of zero. By using the multi-wavelength method, synthetic wavelengths in the meter range can be generated, so that the uniqueness range of the height levels can be expanded accordingly.

Height levels can only be interpreted clearly up to a maximum lift, which corresponds to half the synthetic wavelength. It is half the synthetic wavelength because the light travels the same path twice in reflection. This means that a 2π phase jump corresponds to half the wavelength.

The at least two wavelengths are preferably recorded at the same time. The so-called carrier frequency method is suitable for this, which is e.g. described in D. Claus et al.: “Snap-shot topography measurement via dual-VCSEL and dual wavelength digital holographic interferometry”, Light: Advanced Manufacturing, pp. 403-414, 2021, doi: https://doi.org/10.37188/lam.2021.029. In the carrier frequency method, the reference beam or a sub-reference beam interferes with the object beam at a certain angle. This angle is chosen in particular such that, on the one hand, the complete information of the object (largest angle of the object beam) is acquired and, on the other hand, the so-called Nyquist sampling theorem is adhered to. In particular, an interference pattern recorded under this condition of oblique incidence of the reference beam enables the phase to be reconstructed using a single recording. The phase can be filtered by extracting the object information in Fourier space, which is shown separate from the steady component and the complex conjugate object information by the carrier frequency. The complex object amplitude can be reconstructed by an inverse Fourier transform of the object information.

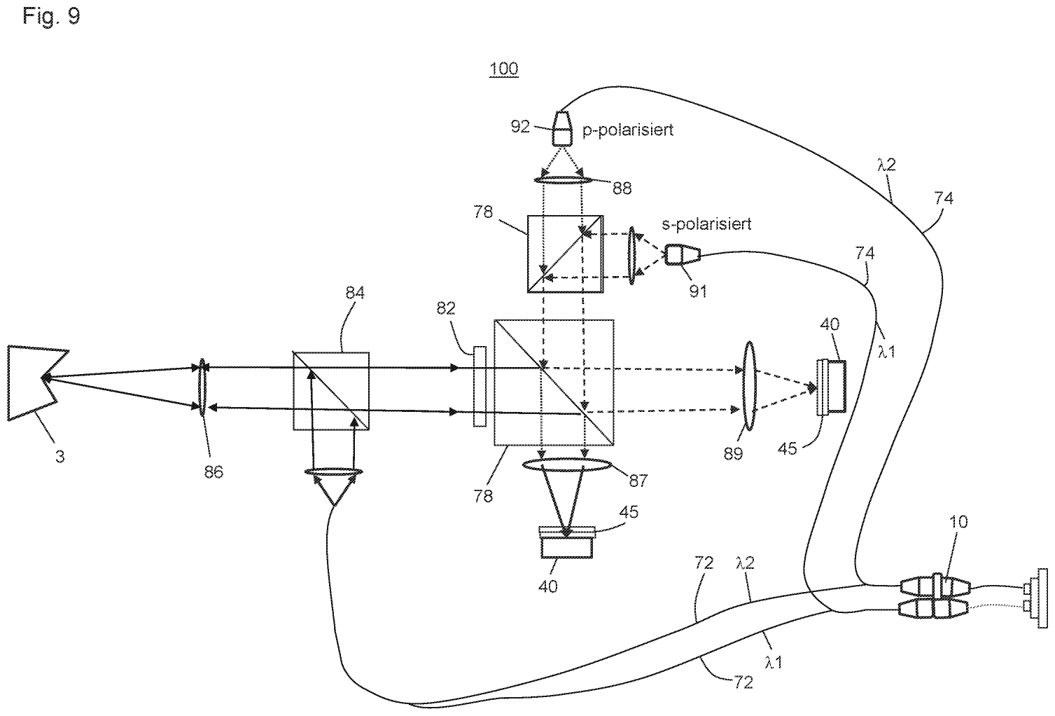

FIG. 9 shows a schematic sketch of a measuring device 100 according to a further preferred embodiment of the invention. In this embodiment, a light source 10, which emits two different wavelengths λ₁ and λ₂, and two identical detectors 40 are used. Here, the information of the two wavelengths λ₁ and λ₂ is recorded separately from each other by using polarization-maintaining fibers and using polarization beam splitter cubes 78. The measuring device 100 of FIG. 9 also comprises two polarization arrays 45 in front of each detector 40 (in particular a λ/4 at 45° and 2×2 polarization array arranged over 2×2 pixels each, so that with a sensor of 1000×1000 pixels for each polarization direction 500×500 pixels are available), a 45° polarizer 82, lenses 86, 87, 88 and 89, an s-polarized fiber output 91, and a p-polarized fiber output 92. The beam paths with different dashed lines in FIG. 9 differentiate between s- and p-polarized light. Specifically, a dashed line represents s-polarized light, while a dotted line represents p-polarized light.

Alternatively or in addition, both wavelengths can also be temporally sinusoidally modulated, so that the wavelength-associated signals can then be separated from one another using a temporal Fourier transform or the digital lock-in method and the phase can be determined at each individual point in time. In the case of digital lock-in, the measurement signal Ms is multiplied by the sine and cosine of the original, preferably sinusoidally modulated, laser beam of the corresponding wavelength coming directly from the laser:

$$Phi\_λ 1 = arc tan ( Ms * sin ( f\_λ 1 ) / Ms * cos ( f\_λ 1 ) )$$

The phase at the respective excitation frequency (f_λ1) is then calculated using an arctan function of the two products. The other frequencies are suppressed here. The same procedure is also carried out for the other wavelengths involved in the measurement. A temporally sinusoidal modulation of the wavelength can be achieved e.g. by an amplitude modulation and/or by a sinusoidal change in the current applied to the laser and/or by means of a frequency generator or microcontroller, etc. In addition to the digital lock-in method, the Fourier transform can also be used along the temporal axis for filtering or extraction in order to separate the different modulation frequencies from each other.

Preferably, for each wavelength, the respective phase of the pixel in the object space or in the image plane is calculated pixel by pixel after subtracting the modulation frequency in Fourier space. Subsequently, the phase maps corresponding to wavelengths are subtracted from each other, so that the phase map of a synthetic wavelength is obtained. If the movement of the scattering particles between two recordings is very small, so that there is no decorrelation of the recorded scattered light interferograms or holograms, sequential methods can be used as well. “Sequential methods” are understood to mean that first a holographic image is recorded using light of a first wavelength and then one or more holograms are recorded using light of additional wavelengths. The above-mentioned principle of synthetic wavelength also applies to these sequential methods.

There are many technical solutions that enable rapid recording of at least two images in quick succession. For example, there are so-called frame transfer sensors in which the entire sensor is duplicated so that only the electrons are transferred from one sensor to the other sensor, which is shaded from light. Thus, short interframe times of a few nanoseconds are possible.

The two necessary wavelengths can be generated e.g. with at least two different lasers. However, in terms of compactness and costs it is advantageous to use only one light source. For example, by means of an acousto-optical modulator, the wavelength can be changed by changing the frequency, so that the holograms of at least two wavelengths can be recorded in a temporally sequential order. Alternatively or in addition, the wavelength can be detuned by changing the current applied to the laser.

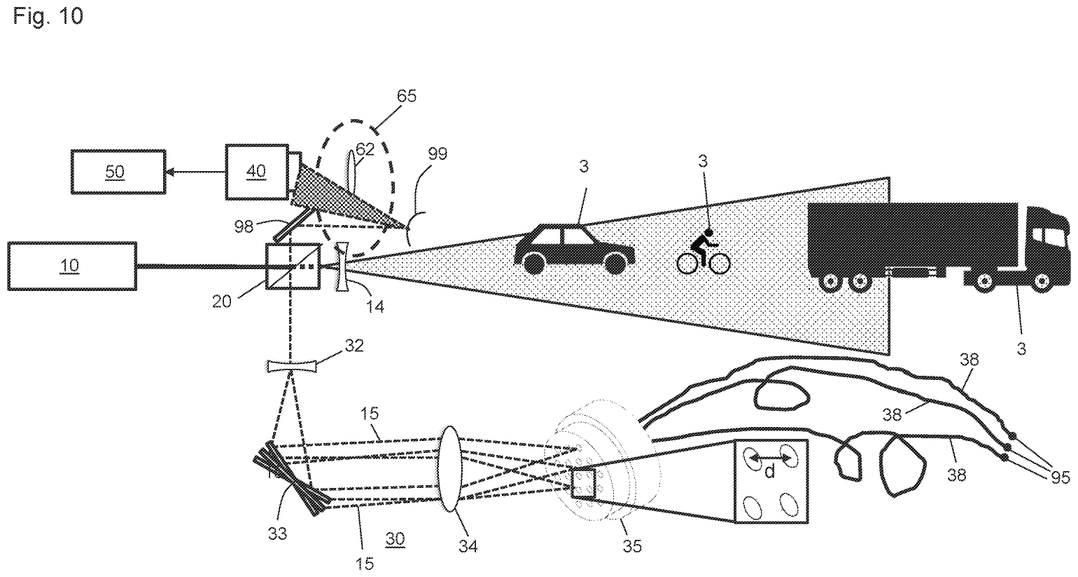

In holographic image registration, it is not necessary to synchronize the camera recording of a single image with the time of radiation input into a single fiber, which simplifies the development of the optical signal registration system. However, there may be applications in which the majority of the backscattered or backreflected light comes not just from one surface, but from multiple surfaces. In this case, it can be advantageous to sequentially tune the different optical path lengths for the reference beam or for the sub-reference beams. For reasons of compactness, it can be advantageous if the end of the multi-channel fiber connector is mirrored so that the light returns through the fibers on the same path and is directed consistently to the same axis for all optical path lengths via the deflection optics, and for example via the galvo scanner (see FIG. 10). This axis should preferably be oriented slightly tilted with respect to the optical axis of the detector or the image data acquisition unit so that only one recording needs to be made for each optical path length using the spatial carrier frequency method in order to reconstruct the phase.

FIG. 10 shows a schematic sketch of a corresponding exemplary measuring device 100. The basic construction of the measuring device 100 of FIG. 10 is similar to the measuring device shown in FIG. 3, which is why a detailed description is omitted at this point. In contrast to the measuring device of FIG. 3, however, the optical paths or fibers 38 have mirrored end sections 95. Moreover, the measuring device 100 of FIG. 10 also has a deflection system comprising two mirrors 98 and 99 in order to direct the sub-reference beams 15 and the object beam 18 to the image data acquisition unit. Sequential tuning of the different optical path lengths is possible, as shown in FIG. 10, for example using the galvo scanner 33. On its way to the optical fibers 38 and back from the fiber 38, the light substantially passes through the same mirror position of the galvo scanner 33, since due to the high speed of light it has not changed, even with a continuous movement of a measuring vehicle.

In addition, by adding the multi-wavelength method, which can also be performed simultaneously thanks to the carrier frequency method, the measurement sections can be sampled axially even more precisely. In the carrier frequency method, in particular a carrier frequency is modulated and/or the carrier frequency angle (or interference angle) is changed, which enables the object information to be separated for both wavelengths. The spatial carrier frequency method can be implemented in the reference arm using fibers of the same length, which transport different wavelengths, and by different positioning in the fiber connector or fiber holder, so that different interference angles with the object wave result for each wavelength. On the other hand, by adding a grating to the beam dividing cube, different angles of incidence on the detector or 2D sensor could be generated for the wavelengths used. For example, a grating with period G can be used, which generates different diffraction angles after/according to the grating depending on the wavelength. The diffraction angle α is calculated as follows: α=arcsin(λ/G). Further information on this can be found e.g. in M. Rostykus, M. Rossi und C. Moser: “Compact lensless subpixel resolution large field”, Opt. Letters, Bd. 43, Nr. 8, pp. 1654-1657, 2018, DOI: 10.1364/OL.43.001654.

The addition of the multi-wavelength method offers the particular advantage that volume scattering by the fog is strongly suppressed, since the scattering properties are very similar when using neighboring wavelengths (wavelength difference less than 1 nm). Thus, by subtracting the reconstructed phase images of the different wavelengths, one can not only improve visibility, but even represent the 3D contour of the object. Here, a phase image refers to the phase component of the reconstructed complex object amplitude, which is obtained by process steps of filtering the recorded hologram in Fourier space and the inverse Fourier transform. In particular, the phase images of the different wavelengths are subtracted from each other, so that a difference phase image that corresponds to a significantly larger synthetic wavelength is created. A longer wavelength has the advantage that the axial uniqueness range (e.g. height when steps occur) is expanded. This is particularly advantageous for applications in which the interferometrically recorded measurement section is in the meter range, in order to be able to clearly reconstruct the contour.

In principle, the contour of a detected object can be reconstructed using only one wavelength if a smaller coherence length is used and correspondingly smaller length differences between the fibers (a few cm). One would then have to scan through the different interference sections, so that a longer recording time would be necessary than is the case with the two-wavelength method, since here only the information of two different wavelengths has to be recorded. The carrier frequency method even makes it possible to record the required information from both wavelengths interferometrically in just one recording.

If you want to acquire the interferometric measurement section even more finely axially by adding two wavelengths so that the contour becomes visible, the corresponding synthetic wavelength should preferably correspond approximately to the coherence length. With a coherence length of e.g. 3 m, a second wavelength of 1063.9996 nm would be required for a first wavelength of e.g. 1064.0000 nm. This means that the wavelength offset is only a few picometers.

For example, per one fiber channel, it is possible to couple light with at least two wavelengths into the fiber channel. In this case, the integration time must be increased accordingly. However, embodiments are also possible in which, using a diffraction grating on the beam splitter on which the sub-reference beams are superimposed with the object beam, the light hits the camera sensor in different directions depending on the wavelength. In this way, the information of the two wavelengths can be separated from each other using Fourier transform.

Alternatively, per one wavelength, one separate fiber of the same length can be used. However, optical components deflecting the different wavelengths coming from the same fiber in different angles, preferably in one camera recording, are preferably used. Otherwise the number of fibers would increase accordingly.

The present invention makes it possible, in particular, to link the methods of digital holography and coherent tomography, for example to determine the distance and/or the contours or dimensions of objects, even in poor visibility conditions. In particular, the invention enables a reconstruction of the 3D shape of objects combined with the reproduction of the distance in space in relation to the measuring device, which can also be in motion. The distance of an object from the measuring vehicle can be determined in particular on the basis of OCT, namely by determining from the plurality of reference channels those reference channels that, after an FFT, lead to a recognizable interference signal or a recognizable diffraction order. The distances to moving objects can then be deduced from the lengths of the determined reference channels. The dimensions of detected objects can be determined in particular on the basis of digital holography, namely by means of a computational or numerical reconstruction of at least one recorded digital hologram. Furthermore, the contour of a detected object can be acquired in particular by adding a second wavelength and using the multi-wavelength method.

### REFERENCE NUMERAL LIST

1 vehicle with measuring device (measuring vehicle)
3 object
10 laser (light source)
11 collimator
12 measuring beam
13 reference beam
14 scattering lens
15 sub-reference beam
18 object beam
20 beam splitter
30 reference beam transfer unit
31 mirror
32 scattering lens
33 galvo scanner
34 lens/scanning lens/converging lens
35 fiber connector
35a input of the fiber connector
35b output of the fiber connector
37 input of an optical fiber (input of an optical path)
38 optical fiber (optical path/reference channel)
39 output of an optical fiber (output of an optical path)
40 detection unit/camera (image data acquisition unit)
45 polarization array
50 evaluation unit
60 lens
65 optical axis
68 beam splitters
78 polarization beam splitter cube
82 polarizer
84 beam splitter
86 lens
87 lens
88 lens
89 lens
91 s-polarizer
92 p-polarizer
95 mirrored end section
98 mirror
99 mirror
100 measuring device
150 Fourier space
d distance
L length
N number of optical paths
τ pulse duration
T duration of an image recording

1. A measuring device configured to detect at least one object and/or for determine at least one object distance, comprising:
a light source configured to emit light with a predetermined coherence length;
a beam splitter configured to split the light emitted by the light source into a measuring beam and a reference beam;
a reference beam transfer unit configured to convert the reference beam into a plurality of sub-reference beams;
an image data acquisition unit configured to acquire image data resulting from a superposition of the sub-reference beams with an object beam, the object beam comprising at least a part of the measuring beam that was scattered and/or reflected by the at least one object; and
an evaluation unit configured to evaluate the image data acquired by the image data acquisition unit;
wherein the reference beam transfer unit comprises a plurality of spatially separated optical paths, each with different optical lengths, along which the sub-reference beams are guided to the image data acquisition unit.

2. The measuring device according to claim 1, wherein the reference beam transfer unit has N optical paths, and wherein for all n∈{2, 3, 4, . . . , N} the optical length of an n^{th} optical path differs from the optical length of an (n−1)^{th} optical path by the predetermined coherence length.

3. The measuring device according to claim 1, wherein the plurality of optical paths of the reference beam transfer unit comprises a plurality of optical fibers and/or optical waveguides.

4. The measuring device according to claim 1, wherein the plurality of optical paths comprises a plurality of optical fibers, and wherein the reference beam transfer unit comprises scanning optics with which the reference beam can be successively coupled into the optical fibers.

5. The measuring device according to claim 4, wherein the reference beam transfer unit comprises a multi-channel fiber connector in which the plurality of optical fibers is arranged at least in some areas.

6. The measuring device according to claim 5, wherein the optical fibers in the fiber connector are arranged such that, in a top view of the fiber connector, end sections of the optical fibers, from which the sub-reference beams exit, are located on the points of a two-dimensional hexagonal grating.

7. The measuring device according to claim 1, further comprising an optical lens arranged such that the sub-reference beams, which exit the reference beam transfer unit, impinge on the optical lens and are each deflected by it at different angles with respect to an optical axis of the lens.

8. The measuring device according to claim 1, wherein the predetermined coherence length of the light emitted by the light source is in a range of 1 m to 5 m.

9. The measuring device according to claim 1, wherein the evaluation unit is further configured to evaluate interference images and/or holograms acquired by the image acquisition unit, which result from a superposition of the object beam with the sub-reference beams.

10. The measuring device according to claim 1, wherein the evaluation unit is further configured to:
determine from the plurality of sub-reference beams the sub-reference beam or sub-reference beams that caused interference with the object beam; and/or
determine at least one object distance on the basis of an interference image resulting from a superposition of the object beam with the sub-reference beams and further by taking the predetermined coherence length into account; and/or
perform a computational reconstruction of a digital hologram; and/or
determine a contour of the at least one object on the basis of a digital hologram, which results from a superposition of the object beam with the sub-reference beams.

11. A vehicle including a measuring device according to claim 1.

12. A method for detecting an object and/or for determining at least one object distance, comprising:
providing a measuring device according to claim 1; and
evaluating an interference image and/or a digital hologram, which results from a superposition of the object beam with the sub-reference beams.

13. The method according to claim 12, comprising:
carrying out a Fourier transform in order to transfer the image data acquired by the image data acquisition unit into the Fourier space;
based on the result of the Fourier transform carried out, determining at least one sub-reference beam that caused destructive and/or constructive interference with the object beam;
determining the optical path length traveled by the at least one interfering sub-reference beam by identifying the at least one optical path along which the at least one interfering sub-reference beam was guided to the image data acquisition unit; and
determining at least one object distance on the basis of the at least one determined optical path length and also on the basis of the predetermined coherence length of the light emitted by the light source.

14. The method according to claim 12, comprising:
carrying out a computational reconstruction of a digital hologram recorded by the image data acquisition unit; and
determining at least one dimension and/or at least one contour of the at least one object on the basis of the reconstruction carried out.

15. The method according to claim 14, further comprising:
the light source of the measuring device emitting light with two predetermined different wavelengths, and
determining the at least one dimension and/or at least one contour of the at least one object using multi-wavelength holography.

16. The measuring device according to claim 1, wherein the plurality of optical paths comprises a plurality of optical waveguides, and wherein the reference beam transfer unit comprises a waveguide system with which the reference beam can be successively coupled into a plurality of optical waveguides by using thermal effects.

17. The measuring device according to claim 1, wherein the optical paths each have a mirrored end section.

18. The measuring device according to claim 1, further comprising the light source emitting light with two predetermined different wavelengths.
